(19) United States
(12) Patent Application Publication
(10) Pub. No.: US 2023/0392759 A1
(43) Pub. Date: Dec. 7, 2023

(54) LIGHT ASSEMBLY, ACCESSORIES AND KIT

(71) Applicant: Blue Sun Products, LLC, Pleasant View, UT (US)

(72) Inventor: Kyle Ellis, Pleasant View, UT (US)

(73) Assignee: Blue Sun Products, LLC, Pleasant View, UT (US)

(21) Appl. No.: 17/832,230

(22) Filed: Jun. 3, 2022

(51) Int. Cl. F21L 4/00; F21V 21/40; F21V 21/14; F21V 21/088

(52) U.S. Cl. CPC F21L 4/005; F21V 21/406; F21V 21/145; F21V 21/0885; F21Y 2115/10

(57) ABSTRACT

Embodiments of the invention include a light assembly configured to selectively deliver a light beam in a direction along an assembly axis, with circular magnetic couplings located coaxially and radially for receiving accessories, according to various embodiments. Embodiments of the accessories may include, for example and not by way of limitation, a tripod, extension arm, carabiner accessory, spring clamp accessory, sliding spring clamp accessory, wristband accessory, barrel mount accessory, picatinny rail mount accessory and belt mount accessory. Kit embodiments including the light assembly and various combinations of the accessories are also disclosed.

### BACKGROUND OF THE INVENTION

### Field of the Invention

The present invention relates generally to lighting systems. More particularly, this invention relates to a light assembly, accessories and kit.

### Description of Related Art

Handheld lighting systems, such as battery powered flashlights, are well-known in the art. It would be advantageous to have multifunction light assembly that can be used as a handheld flashlight, or alternatively mounted to objects, or to surfaces, for use in a hands-free manner. It would also be useful if such a multifunction light assembly were available as a kit such that the user could select components, accessories and features for use in any given lighting application.

Accordingly, there exists a need in the art for a novel and nonobvious light assembly, kit and accessories for same.

### SUMMARY OF THE INVENTION

Embodiments of the invention include various embodiments of a light assembly. An exemplary embodiment of a light assembly according to the present invention may include a cylindrical-shaped battery housing configured to house a battery, the battery housing having and an assembly axis, a proximal end and a battery housing distal end, the proximal end configured to receive an end cap, the end cap configured with a disk-shaped magnet and together forming a coaxial circular magnetic coupling. The battery housing may further include a radially-mounted socket disposed on an outside surface between the proximal end and the battery housing distal end. The socket may also be configured to receive a disk-shaped magnet and together forms a radial circular magnetic coupling with a radial circular magnetic coupling axis perpendicular to the assembly axis. The battery housing distal end may be configured with a circular shoulder having an external circular groove to receive a retaining ring. The coaxial and radial circular magnetic couplings are each configured to magnetically couple to magnetic surfaces. The embodiment of a light assembly according to the present invention may further include a cylindrical-shaped electronics housing configured to house a light source for generating a light beam. The light source may be powered by the battery. The electronics housing may further be configured with an electronics housing proximal end and a distal end. The housing proximal end may be configured to mate around the circular shoulder of the battery housing and be configured with external threading and an internal groove configured to receive an O-ring to achieve a water-resistant seal.

Various magnetically attachable accessories to the various embodiments of a light assembly are also disclosed, including: a tripod, a bendable extension arm, a carabiner accessory, a spring clip accessory, a sliding spring clip accessory, an armband accessory, a picatinny rail accessory, a barrel mount accessory and a belt mount accessory. These accessories are configured to magnetically connect to the coaxial or radial circular magnetic couplings on the embodiments of a light assembly. Kit embodiments of a light assembly including any suitable combination of the above accessories are also disclosed.

Additional features and advantages of the invention will be apparent from the detailed description which follows, taken in conjunction with the accompanying drawings, which together illustrate, by way of example, features of embodiments of the present invention.

### BRIEF DESCRIPTION OF THE DRAWINGS

The following drawings illustrate exemplary embodiments for carrying out the invention. Like reference numerals refer to like parts in different views or embodiments of the present invention in the drawings.

FIG. 1 is an exploded perspective view of a light assembly, according to the present invention.

FIGS. 2A-2G illustrate rear, left side, top, right side, bottom, front and perspective views, respectively, of the embodiment of a light assembly shown in FIG. 1, according to the present invention.

FIG. 3 is a perspective view of another embodiment of a light assembly including an embodiment of tripod, according to the present invention.

FIG. 4 is a perspective view of yet another embodiment of a light assembly including an embodiment of tripod, according to the present invention.

FIG. 5 is a perspective view of an embodiment of a light assembly including embodiments of tripod and a bendable extension arm, according to the present invention.

FIG. 6 is a perspective view of yet another embodiment of a light assembly including embodiments of tripod and a bendable extension arm, according to the present invention.

FIG. 7 is a perspective view of still another embodiment of a light assembly including embodiments of a bendable extension arm and carabiner accessory, according to the present invention.

FIG. 8 is a perspective view of an embodiment of a light assembly including embodiments of a tripod and carabiner accessory, according to the present invention.

FIG. 9 is a perspective view of an embodiment of a light assembly including embodiments of a tripod and spring clip accessory, according to the present invention.

FIG. 10 is a perspective view of an embodiment of a light assembly including embodiments of a tripod and sliding spring clip accessory, according to the present invention.

FIG. 11 is a perspective view of another embodiment of a light assembly including embodiments of a tripod and an armband accessory, according to the present invention.

FIG. 12 is a perspective view of yet another embodiment of a light assembly including an embodiment of a picatinny rail mount accessory, according to the present invention.

FIG. 13 is a perspective view of yet another embodiment of a light assembly including an embodiment of a barrel mount accessory, according to the present invention.

FIG. 14 is a perspective view of yet another embodiment of a light assembly including an embodiment of a belt mount accessory, according to the present invention.

FIG. 15 is a cutaway view illustrating internal detail of another embodiment of a light assembly according to the present invention.

### DETAILED DESCRIPTION

Various embodiments of a light assembly are disclosed herein. Embodiments of a light assembly can function as a hand-held flashlight. Other embodiments of a light assembly are configured to be free-standing or temporarily attached to objects to allow for directed, hands-free lighting with various accessories that are magnetically attachable to base embodiments 100 and 200A of the light assemblies disclosed herein.

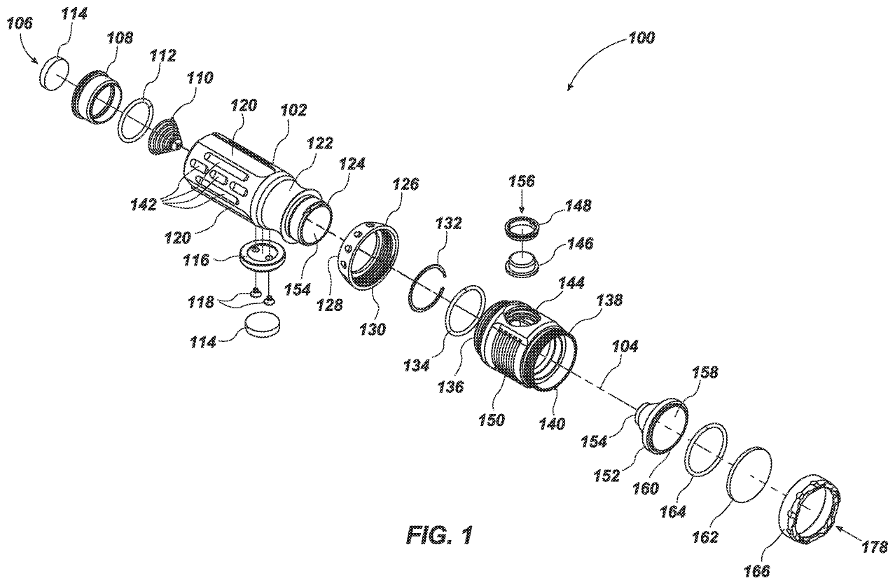

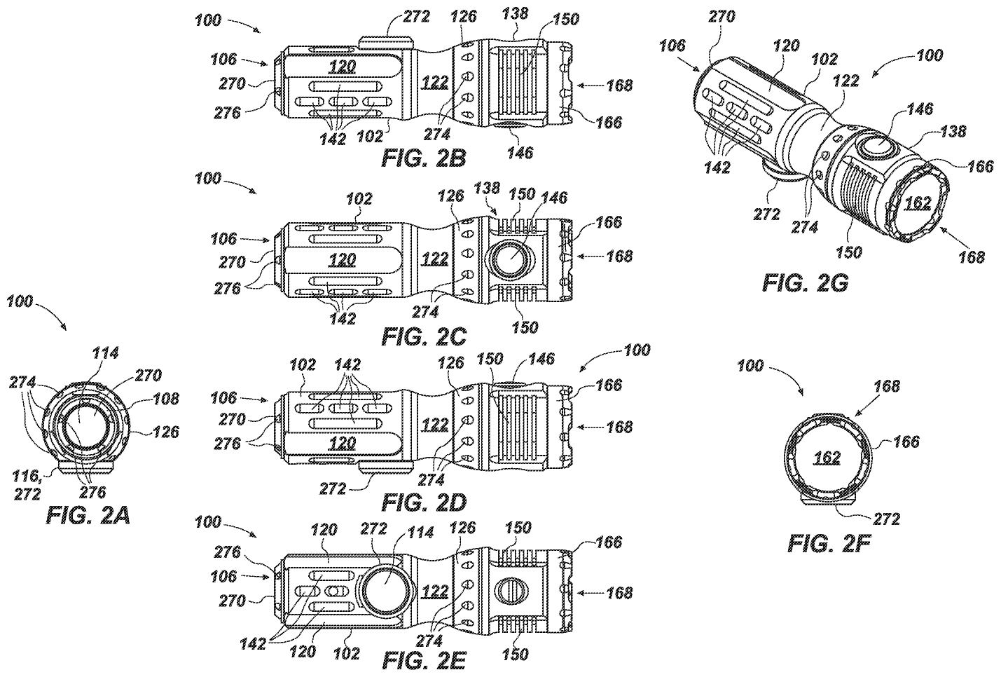

FIG. 1 is an exploded assembly view of an embodiment of a portable light assembly 100 according to the present invention. Embodiments of light assembly 100 include an assembly axis 104 about which its components are shown in exploded view. Battery housing 102 is hollow and configured to receive a battery (not shown) and provides a generally cylindrical shape, convenient for gripping in the user's hand (not shown). The proximal end 106 of the light assembly 100 is enclosed by an end cap 108 securing a coil spring 110 via threading with an O-ring 112 for sealing the end cap 108 to the proximal end 108 of the battery housing 102. Embodiments of the coil spring 110 may be cylindrical as shown in FIG. 1 or any other suitable shape for making contact to one end of the battery (not shown). Coil springs 110 used for making contact to a battery (in flashlights and other devices) are well known to those of ordinary skill in the art and thus will not further elaborated herein. End cap 108 may further be configured to receive a disk-shaped magnet 114 thereby forming a coaxial circular magnetic coupling 232 (best shown in FIG. 2A, see also FIGS. 2B-2E).

According to one embodiment, battery housing 102 may further be configured to receive a radially-mounted socket 116 secured to the battery housing 102 with screws 118 (two shown in FIG. 1). Other means suitable for securing the radially-mounted socket 116 to the battery housing 102 are contemplated to be within the scope of the present invention, including mating threads, adhesives, etc. known to those of ordinary skill in the art. Bottom socket 116, like end cap 108, is configured to receive a disk-shaped magnet 114. The radially-mounted socket 116 with disk-shaped magnet 114 together form a radial circular magnetic coupling 238 (best shown in FIGS. 2A, 2D, 2E and 2G.)

According to one embodiment, battery housing 102 may further be configured with a plurality of arm slots 120 formed into the outer surface of the battery housing 102 extending from the end cap 108 toward a reduced diameter waist 122 adjacent to a central opening 124 having a recess for receiving a retaining ring 132. According the illustrated embodiment, battery housing may further include handgrip flutes 142 of various lengths and shapes configured to give the light assembly 100 a textured grip, weight reduction and an aesthetic appearance.

As shown in the exploded view of FIG. 1, light housing 100 may further include an annular nut 126 having a smaller diameter end 128 and a larger diameter end 130. The smaller diameter end 128 may be configured to mate with the rim 124 surrounding central opening 154 by sliding over rim 124, according to the illustrated embodiment of light assembly 100. According to this embodiment, rim 124 may be configured with a circumferential recess configured to receive retaining ring 132 once inserted through smaller diameter end 128 of nut 126.

According to still another embodiment, central opening 124 may be threaded and configured to mate directly with mating threads on a first end 136 of electronics housing 138 without the need for retaining ring 132. While this particular embodiment is not illustrated, it will be understood that such threaded engagements are well known to those of ordinary skill in the art and thus will not be further elaborated herein. As illustrated, and in accordance with both engagement embodiments (retaining ring and without) a sealing O-ring 134 may be used between the nut 126 and the first end 136 of electronics housing 138 to form a water-tight seal if needed and to protect the battery and electronics (neither shown) from the elements during use.

Electronics housing 138 may further include a radial opening 144 for receiving a button cover 146 held in place by an annular cover retainer 148. The button cover 146 and cover retainer 148 together form a switch 156 used to selectively switch battery power from the battery (not shown) to the optical radiation (light) source (also not shown) to turn the light assembly on and off. A plurality of circumferential grooves 150 may be formed circumferentially around the outer surface of the electronics housing 138, again for similar reasons to the handgrip flutes 142, namely, to provide a textured grip, weight reduction and an aesthetic appearance.

The second end 140 of the electronics housing 138 may be configured to receive an optical reflector 152 generally funnel-shaped having a narrow annular opening 154 (not shown in perspective view of FIG. 1, but located at the narrow end of the funnel shaped optical reflector 152) for receiving an optical radiation source (not shown, but e.g., light bulb, light-emitting diode (LED), etc.) and collimating a light beam (not shown) emanating from the radiation source (not shown) in a direction along the assembly axis 104. The internal reflective surface 158 which opens up to the wide rim 160 of the optical reflector 152 may have a parabolic or other selectively-shaped cross-section when cut along a plane passing through and encompassing the assembly axis 104, according to various embodiments. The internal reflective surface 158 may be configured for directing the light beam in various suitable directions according other embodiments. Such optical reflectors 152 and their various shapes, compositions and methods of manufacturing are well-known those of ordinary skill in the art and thus will not be further elaborated herein.

According to another contemplated embodiment not illustrated herein, the optical radiation source, or “bulb”, may configured to move along the assembly axis 104 relative to the optical reflector 152 and within the narrow annular opening 154 thereby providing the user with the ability to selectively focus the light beam emanating from the bulb. This focusing feature may be achieved by various means known to those of ordinary skill in the art and thus will not be further elaborated herein.

According to the embodiment of light assembly 100 shown in FIG. 1, the optical reflector 152, a lens 162 and an O-ring 164 may be secured to threading along around the second end 140 of electronics housing 138 via a bezel 166. The bezel 166 located at a distal end 168 of the light assembly 100 protects the lens 162 and secures the optics of light assembly 100 to the electronics housing 138. O-ring 164 provides a water-tight seal to the optics of light assembly 100 when compressed between the lens 162 and the optical reflector 152. According to two embodiments of the light assembly 100, the O-ring 164 may be clear or translucent. The bezel may be configured any suitable texture for gripping and rotating during assembly and disassembly as well as aesthetic appearance.

Having described an exploded view (FIG. 1) of a particular embodiment of a light assembly 100, we now refer to drawings of an assembled embodiment of the same light assembly 100. More particularly, FIGS. 2A-2G illustrate rear, left side, top, right side, bottom, front and perspective views, respectively, of light assembly 100 according to the present invention. Among the novel and nonobvious features of light assembly 100 are the embodiments of a coaxial circular magnetic coupling 270 (see, FIGS. 2A-2E and 2G) and a radial circular magnetic coupling 272 (see FIGS. 2A, 2B, 2D, 2E and 2G). The magnetic couplings 270, 272 are useful for connecting to separate accessories that provide a number of additional features in combination with the light assembly 100.

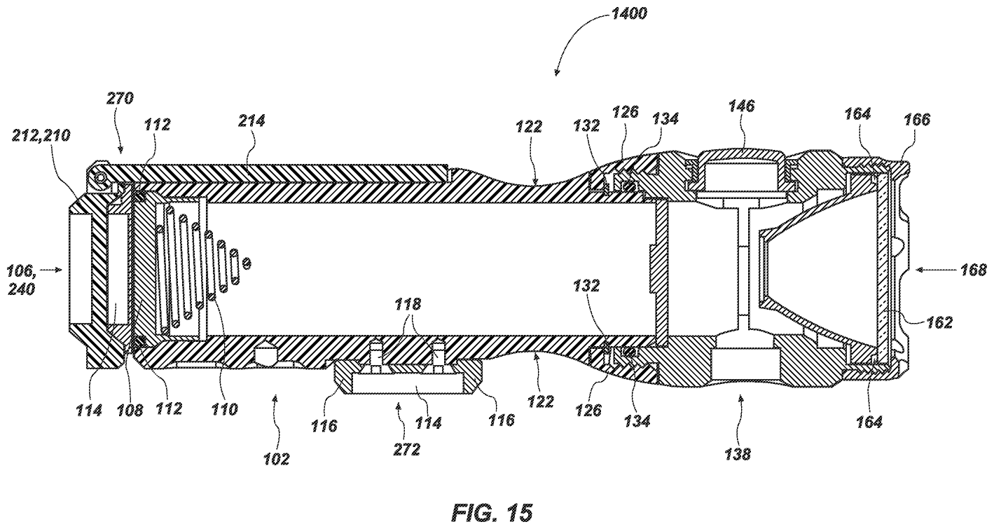

FIGS. 2A-2G illustrate rear, left side, top, right side, bottom, front and perspective views, respectively, of the embodiment of a light assembly 100 shown in FIG. 1, according to the present invention. As best shown in FIG. 2A, the coaxial circular magnetic coupling 270 includes a disk-shaped magnet 114 surrounded by end cap 108. The radial circular magnetic coupling 272 is shown at the bottom of FIG. 2A and also includes a disk-shaped magnet 114 (not visible in FIG. 2A) surrounded by radially-mounted socket 118. The annular nut 126 may include regularly spaced index notches 274 about its circumference providing texture for gripping during assembly and disassembly. As best shown in FIG. 2A, annular nut 126 may comprise the largest diameter of the assembled components, according to this particular embodiment of the light assembly 100. FIG. 2A further illustrates evenly-spaced end cap notches 276 formed in the end cap 108 which provide a surface for a watch-maker's wrench or other spanner tool for tightening or loosening the end cap 108 from the threaded battery housing 102 opening on the proximal end 106. The end cap 108 encloses a spring (see FIG. 15) used to hold a battery (not shown) mechanically in place and to complete a power circuit.

Referring now to the left side view shown in FIG. 2B, the light assembly 100 may include a coaxial circular magnetic coupling 270 on the proximal end 106 (left side of FIG. 2B) and a radial circular magnetic coupling 272 mounted to the battery housing 102 (shown on top surface of battery housing 102). FIG. 2B also illustrates the battery housing 102 secured to the electronics housing 138 by annular nut 126 adjacent to waist 122. Waist 122, as best shown in FIGS. 2B-2E and 2G, may form a centrally located finger and thumb grip portion of battery housing 102 that may be narrower in diameter than the proximal end 106 of battery housing 102 and the adjacent electronics housing 138 toward the distal end 168 of light assembly 100. According to the illustrated embodiment, waist 122 can be smooth and gently curved as shown in FIGS. 2B-2E and 2G. According other embodiments (not shown), waist 122 may take other shapes and have texture, knurling or other surface treatments to improve grip.

FIGS. 2B-2E and 2G illustrate radially extending circumferential grooves 150 disposed on two quadrants of the electronics housing 138. The circumferential grooves 150 are parallel to one another and provide a decorative aesthetic, a textured grip for the electronics housing 138 and may function as a heat sink if needed. FIGS. 2B-2E and 2G further illustrate annular nut 126 with its regularly spaced index notches 274 shown between waist 122 and electronic housing 138. FIGS. 2B-2E and 2G further illustrate arm slots 120 extending from the proximal end 106 of the battery housing 102 toward the waist 122. FIGS. 2B-2E and 2G also illustrate handgrip flutes 142 formed into the surface of battery housing 102 and oriented generally parallel to the assembly axis 104 (see FIG. 1). Handgrip flutes 142 may be located in regions between the three arm slots 120, each of which are disposed 120° apart form one another around the battery housing 102.

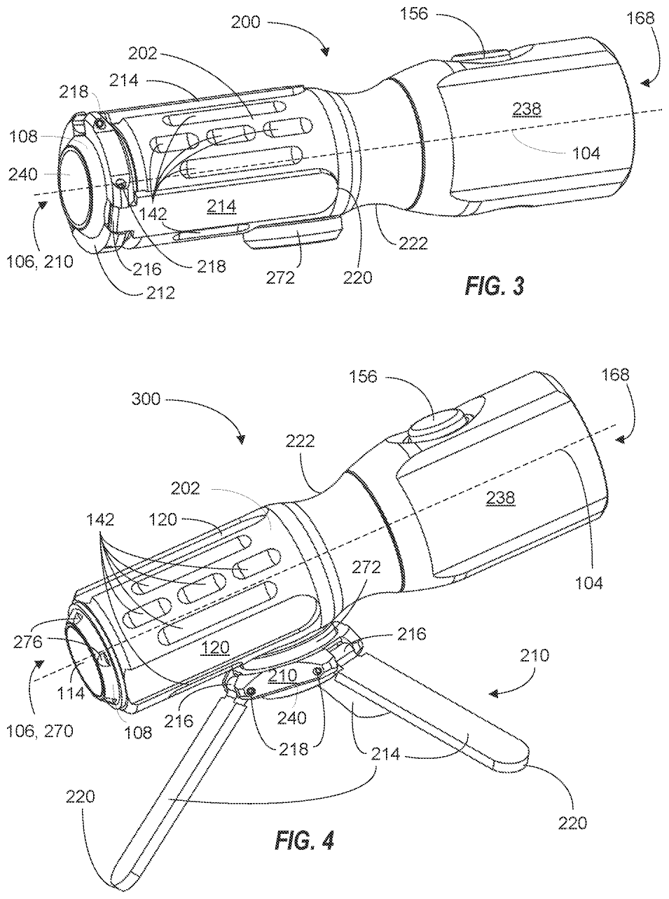

As best shown in the top view shown in FIG. 2C, button cover 146 of light assembly 100 is disposed on a quadrant of the electronics housing 138 between the two sets of opposed circumferential grooves 150. As best shown in FIG. 2E, an embodiment of the radial circular magnetic coupling 272 is shown disposed between two arm slots 120 and adjacent to waist 122 on the battery housing 102. Radial circular magnetic coupling 272 is also shown in part in the views of FIGS. 2A, 2D, 2F and 2G (at bottom) and FIG. 2B (at top). FIGS. 2A-2G all illustrate various views of bezel 166 located at the distal end 168 of light assembly 100 which surrounds and protects lens 162 (best shown in FIGS. 2F and 2G). Having described light assembly 100 with its base features, additional embodiment of components providing improved functionality of the base light assembly 100 will now be described with reference to FIGS. 3-14.

FIG. 3 is a perspective view of another embodiment of a light assembly 200 including an embodiment of tripod, according to the present invention. The embodiment of light assembly 200 also includes a battery housing 202 extending from a proximal end 106 into centrally located waist 222 adjacent to electronics housing 238 located at a distal end 168. This embodiment of light assembly 200 may also include handgrip flutes 142 located on the outer surface of battery housing 202 and in between arm slots (not shown but see 120, FIG. 1 and FIGS. 2B-2E).

The illustrated embodiment of light assembly 200 includes a magnetically coupled tripod 210 disposed on the proximal end 106 of light assembly 200. The embodiment of tripod 210 may include a magnetic tripod base coupling 212 that is generally circular and configured to magnetically couple the tripod 210 to the disk-shaped magnet 114 in the coaxial circular magnetic coupling 270 (not shown in FIG. 3, but see FIG. 4) disposed at the proximal end 106 of light assembly 200. Magnetic tripod base coupling 212 also forms an external circular magnetic coupling The embodiment of tripod 210 may further include three tripod arms 214 evenly spaced about assembly axis 104. The tripod arms 214 are rotationally coupled to the tripod base coupling 212 via rotational couplings 218 at each distal tripod foot end 220. The tripod arms 214 are shown folded closed position, lying flat against the battery housing 202 and more particularly within the arm slots 120 (hidden in FIG. 3, but see, e.g., FIGS. 2B-2E and 4). In this coaxial tripod closed position, the tripod arms 214 are oriented parallel to assembly axis 104. The light assembly 200 with coaxial tripod closed position shown in FIG. 3 is a compact configuration particularly useful as a hand-held flashlight for storage with its tripod 210 attached. Though not illustrated, the tripod 210 could be placed in the open position for placement on a surface (again, not shown) to use with the light source turned on and directed perpendicularly away from the surface, vertically for example.

FIG. 4 is a perspective view of yet another embodiment of a light assembly 300 including also an embodiment of tripod, according to the present invention. The embodiment of light assembly 300 may include the same components and features of light assembly 200, however, the tripod 210 is show coupled to the radial circular magnetic coupling 272 with tripod arms in the open position. It will be understood that in this open position the light assembly 300 may have its light beam directed generally horizontally or in various other directions depending on the degree to which the tripod arms 214 are folded relative to a radial axis (not shown) oriented perpendicular to the assembly axis 104 and passing through the center of the radial circular magnetic coupling 272. FIG. 4 further illustrates disk-shaped magnet 114 housed within end cap 108 and its associated regularly-spaced end cap notches 276 located at the proximal end 106 of light assembly 300.

FIGS. 3 and 4 illustrate other features of light assemblies 200 and 300 including handgrip flutes 142 located on the outer surface of battery housing 202 in locations in between the tripod arms 214 and/or arm slots 120, waist 222 and button switch 156 located on the electronics housing 238. Note that the illustrated embodiment of electronics housing 238 in both light assemblies 200 and 300 have generally recessed smooth cylindrical panels in opposed electronics housing quadrants adjacent to the quadrant supporting the button switch 156. This is in contrast to the circumferential grooves 150 shown in the embodiment of light assembly 100. It will be understood that tripod 210 shown in FIGS. 3 and 4 may be removed and stored separately so that the remaining light assembly can be used alone as a flashlight, according to still other embodiments of the present invention.

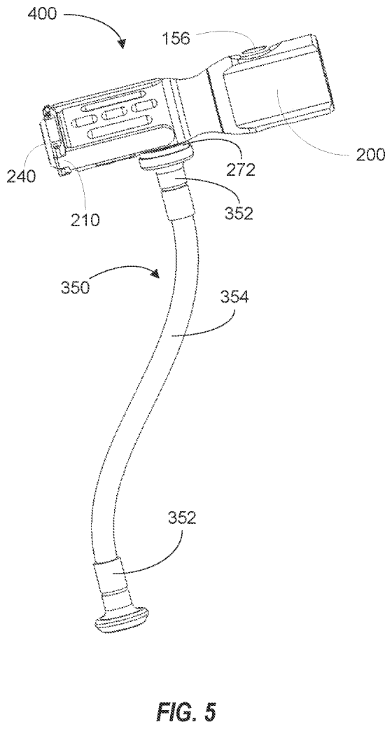

FIG. 5 is a perspective view of an embodiment of a light assembly 400, according to the present invention. Embodiments of light assembly 400 may include light assembly 200 with its axially mounted tripod 210 in the closed position or otherwise (as shown) or without tripod 210 (i.e., light assembly 100, see FIGS. 1 and 2A-G). However, the embodiment of light assembly 400 may further include a bendable extension arm 350 shown coupled to the radial circular magnetic coupling 272 via one of two extension arm magnetic couplings 352, each located at opposite ends of a flexible pipe 354. Bendable extension arm 350 is configured to support a light assembly 100 or 200 with one of the two extension arm magnetic couplings 352 magnetically coupled to a magnetic (e.g., metal) surface. Thus, each of the two extension arm magnetic couplings 352 includes a magnet. Flexible pipe 354 may be formed of any suitable materials that allows semi-rigid support of the light assembly 100 or 200, and yet may be flexed or bent in such a manner to place the light assembly 100 or 200 with its light source directed toward an object of the user's choosing. It will be understood that the bendable extension arm 350 may also be removed from light assembly 400 so that the remaining light assembly can be used as a flashlight.

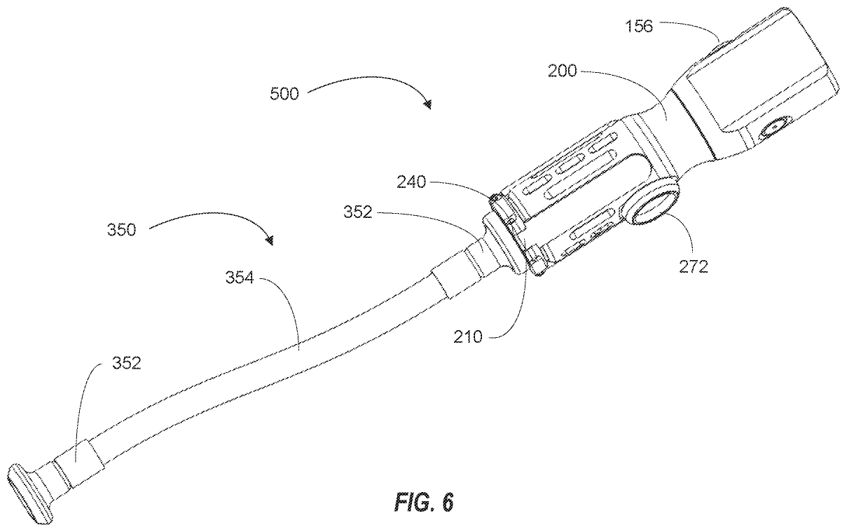

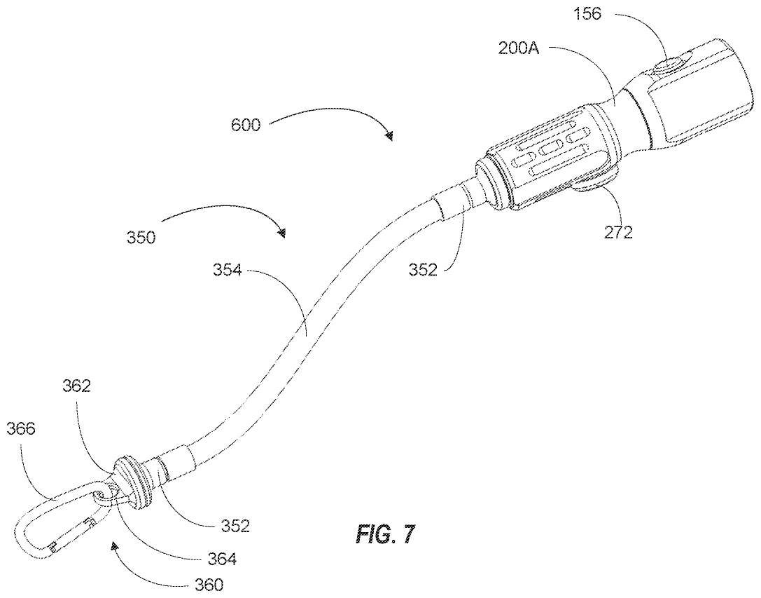

FIG. 6 is a perspective view of yet another embodiment of a light assembly 500 also including embodiments of tripod 210 and a bendable extension arm 350, according to the present invention. Light assembly 500 may include the same components of light assembly 400. However, in the configuration of light assembly 500 shown in FIG. 6, the bendable extension arm 350 may be magnetically coupled to tripod 210 at its external circular magnetic coupling 240 in an axial orientation rather than to radial circular magnetic coupling 272. Thus, the light assembly 500 is magnetically coupled in serial fashion, i.e., the tripod 210 is coupled to coaxial circular magnetic coupling 270 and then one of the extension arm magnetic couplings 352 is magnetically coupled to external circular magnetic coupling 240 of tripod 210. According to other embodiments (not shown) it will be understood that tripod 210 may be removed (see, e.g., 200A FIG. 7) and the bendable extension arm 350 with one of its two extension arm magnetic couplings 352 may be coupled directly to the coaxial circular magnetic coupling 270 of light assembly 100, 200, 300 or 400. In these other axially oriented configurations, the light assembly will operate the same as with the axially mounted tripod 210 in place.

FIG. 7 is a perspective view of still another embodiment of a light assembly 600 including embodiments of a bendable extension arm 350 and carabiner accessory 360, according to the present invention. The embodiment of light assembly 600 is based on a light assembly 200A which is identical to light assembly 200, but with tripod 210 removed from the coaxial circular magnetic coupling 270. In place of the tripod 210, one of the extension arm magnetic couplings 352 of bendable extension arm 350 may be magnetically coupled to the coaxial circular magnetic coupling 270, as shown in the illustrated embodiment. Carabiner accessory 360 may be magnetically coupled to the other extension arm magnetic coupling 352 of bendable extension arm 350 via a circular magnetic ring 362 having an annular opening 364 which may in turn receive a carabiner 366 therethrough. The circular magnetic ring 362 by itself or in combination with the carabiner 366 may be useful for hanging light assembly 600 during use or in storage.

It will be understood that the components of light assembly 600, may come as a kit to be assembled in any suitable combination for use by the user. One such combination is the serial assembly shown in FIG. 7 where the light assembly 200A is coupled to one extension arm magnetic coupling 352 of bendable extension arm 350, with the other extension arm magnetic coupling 352 coupled to circular magnetic ring 362 and finally, carabiner 366 looped through annular opening 364. Though not shown, either coupling 352 of bendable extension arm 350 may also be attached to the radial circular magnetic coupling 372 of light assembly 200. Similarly, the circular magnetic ring 362 may be coupled directly to the coaxial circular magnetic coupling 270 or the radial circular magnetic coupling 272. It will also be understood that bendable extension arm 350 may be of any suitable length.

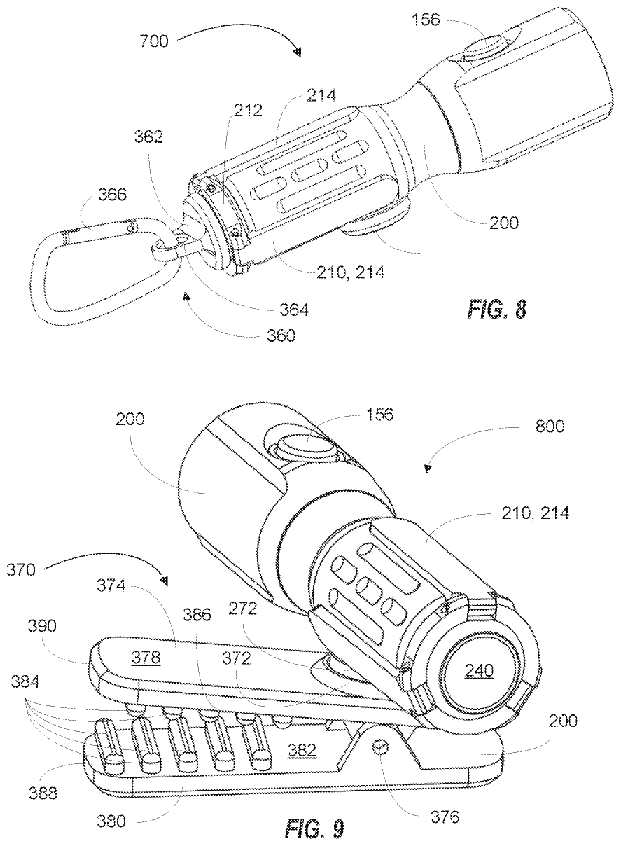

FIG. 8 is a perspective view of an embodiment of a light assembly 700 including embodiments of tripod 210 and carabiner accessory 360, according to the present invention. Light assembly 700 may include light assembly 200 with is tripod 210 connected to the coaxial circular magnetic coupling 270 (not visible in FIG. 8) of light assembly 200. Light assembly 700 may further include carabiner accessory 360 magnetically coupled to external circular magnetic coupling 240 (not visible in FIG. 8) of tripod 210 via circular magnetic ring 362. Light assembly 700 may further include carabiner 366 looped through annular opening 364 as shown in FIG. 8. It will be understood that the components of light assembly 700, may come as a kit to be assembled in any suitable combination for use by the user. One such combination is illustrated in FIG. 8. However, in another combination, the carabiner accessory 360 may be directly attached to light assembly 200 with the tripod 210 removed (i.e., light assembly 200A). In yet another combination, the carabiner accessory 360 may be directly attached to the radial circular magnetic coupling 272 of light assembly 200 with tripod 210 coupled to the coaxial circular magnetic coupling 270. In still another combination the components 200, 210, 362 and 366 are simply unconnected components in a kit ready to be assembled in any suitable combination the user prefers.

FIG. 9 is a perspective view of an embodiment of a light assembly 800 including embodiments of a tripod 210 and spring clip accessory 370, according to the present invention. The embodiment of light assembly 800 may include a light assembly 200 with its tripod 210 (shown mounted to coaxial circular magnetic coupling 270 (not visible in FIG. 9). The embodiment of light assembly 800 may further include spring clip accessory 370 shown coupled to radial circular magnetic coupling 272. The embodiment of a spring clip accessory 370 may include a clip circular magnetic coupling 372 disposed on an outer surface 378 of a first clip arm 374 opposite a spring pivot mechanism 376. The embodiment of a spring clip accessory 370 may further include a second clip arm 380 rotationally coupled to the first clip arm 374 via the spring pivot mechanism 376. The inner surface 382 of the second clip arm 380 may further include a plurality (five shown) of teeth 384 located generally toward a second distal end 388. A corresponding set of teeth 384 are also located generally toward a first distal end 390 on the inner surface 386 of the first clip arm 374.

The spring pivot mechanism 376 may be biased toward the closed position (not shown). The open position, shown in FIG. 9 may be achieved by gripping proximal ends (opposite first 390 and second 388 distal ends and partially hidden in the view of FIG. 9) of arms 374 and 380 toward one another thereby opening a space between the opposed teeth 384. In the open position, a user may place support structure (not shown) in the space between the teeth 384 and then release the proximal ends thereby clamping the spring clip accessory 370 and its attached light assembly 900 to the support structure for hands-free use. The teeth 384 may be configured to interdigitate when the spring clip accessory 370 is in closed position (open position shown in FIG. 9). The spring clip accessory 370 is configured to grip objects or structure between teeth 384. The spring clip accessory 370 may include a biasing spring (not shown) and pivoting support structure mounted to the inner surfaces 386 and 382 of the first 374 and second 380 arms. Such biasing springs and pivoting support structure are well known to those of ordinary skill in the art, and thus, will not be further elaborated herein.

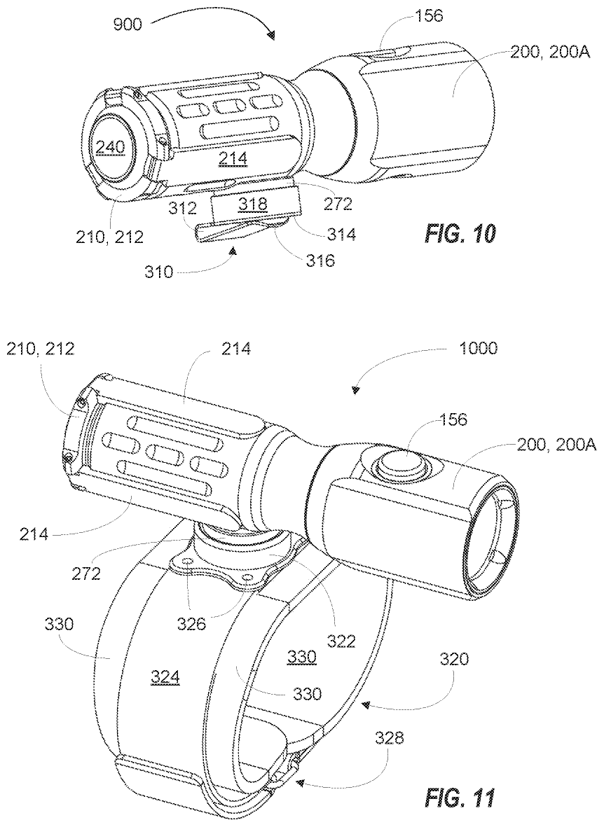

FIG. 10 is a perspective view of an embodiment of a light assembly 900 including embodiments of a tripod 210 and sliding spring clip accessory 310, according to the present invention. The embodiment of light assembly 900 may include an embodiment of a light assembly 200 with an embodiment of a tripod 210 shown connected to coaxial circular magnetic coupling 270 in closed position. The embodiment of light assembly 900 may include a sliding spring clip accessory 310 magnetically coupled to radial circular magnetic coupling 272 of light assembly 200. The illustrated embodiment of a sliding spring clip accessory 310 may include a sliding spring clip 312 configured much like a conventional belt clip with its associated straight arm 314 and opposed curved end arm 316 used to attach tools or accessories to the waist of a user. However, the novel and nonobvious feature of this spring clip 312 is the attachment of circular magnetic coupling 318 permanently attached to the straight arm 314. This embodiment of a circular magnetic coupling 318 incorporates a disk-shaped magnet (not shown) and is configured to magnetically couple to the radial circular magnetic coupling 272 of light assembly 200.

It will be understood that light assembly 900 shown in FIG. 10 gives the user a light source that can be attached to the user's belt and aimed by pivoting the light assembly 200 about the radial circular magnetic coupling 272 for hands-free use. It will be further understood that an embodiment of light assembly 900 may be in kit form, i.e., separate components 200, 210 and 310, ready to assembly and use as the user sees fit. It will be understood that according to one embodiment, the light assembly 900 may used without the tripod 210. It will be further understood that according to other embodiments, the light assembly 900 may be used with the sliding spring clip accessory 310 coupled to the external circular magnetic coupling 240 of tripod 210 or directly, or alternatively coupled directly to the coaxial circular magnetic coupling 270 (hidden from view in FIG. 10) without the tripod 210.

FIG. 11 is a perspective view of another embodiment of a light assembly 1000 including embodiments of a tripod 210 and an armband accessory 320, according to the present invention. The embodiment of light assembly 1000 may include a light assembly 200 with a tripod 210 (shown magnetically coupled to the coaxial circular magnetic coupling 270 in closed position). The embodiment of light assembly 1000 may further include an embodiment of an armband accessory 320 configured to magnetically coupled to a radial circular magnetic coupling 272 as shown. In FIG. 11, the embodiment of an armband accessory 320 may include an armband circular magnetic coupling 322 secured to an armband 324 via a plurality of rivets 326 (two shown). It will be understood that the armband circular magnetic coupling 322 may be secured to an armband 324 with other means for fastening, for example and not by way of limitation: screws, nuts and bolts, adhesive and other fasteners known to those of ordinary skill in the art. Embodiments of armband 324 may be formed from nylon webbing, polyurethane, leather, metal mesh or other materials commonly used for wristbands or armbands and known to those of ordinary skill in the art. It will be understood that armband 324 may also be configured with hook and loop fasteners (not illustrated) and a suitable buckle 328 for adjusting and securing the armband 324 to an arm or wrist of a user. The use of hook and loop fasteners with wrist and armbands are well known to those of ordinary skill in the art and thus will not be further elaborated herein.

Embodiments of armband 324 may further include a layer of foam padding 330 disposed inside of the loop formed by armband 324 for improved user comfort during use of light assembly 1000. In use, light assembly 1000 may be secured to an arm or wrist of a user (none shown) using the buckle 328 and hook and loop fasteners attached to the armband 324 and aimed by swiveling the light assembly 200 about the radial circular magnetic coupling 272. It will be understood that other means of securing armband 324 to the wrist or arm of a user may also be used consistent with the teachings of the present invention, including for example and not by way of limitation: conventional buckle with pin and strap holes, post and strap holes (like those used with an Apple Watch®), clamping buckles, etc. In yet another embodiment of light assembly 1000, the various components: light assembly 200A, tripod 210 (or in combination as light assembly 200), and armband accessory 320 may be provided separately as a kit to be assembled by the user as he or she sees fit. As with other embodiments of light assemblies 200, 300, 400, 500, 600, 700, 800 and 900 featuring removable and attachable accessories disclosed herein, the various components: light assembly 200A, tripod 210, and armband accessory 320 of light assembly 1000 may be selectively combined to obtain various configurations or embodiments of a light assembly not specifically illustrated but within the scope of the present invention.

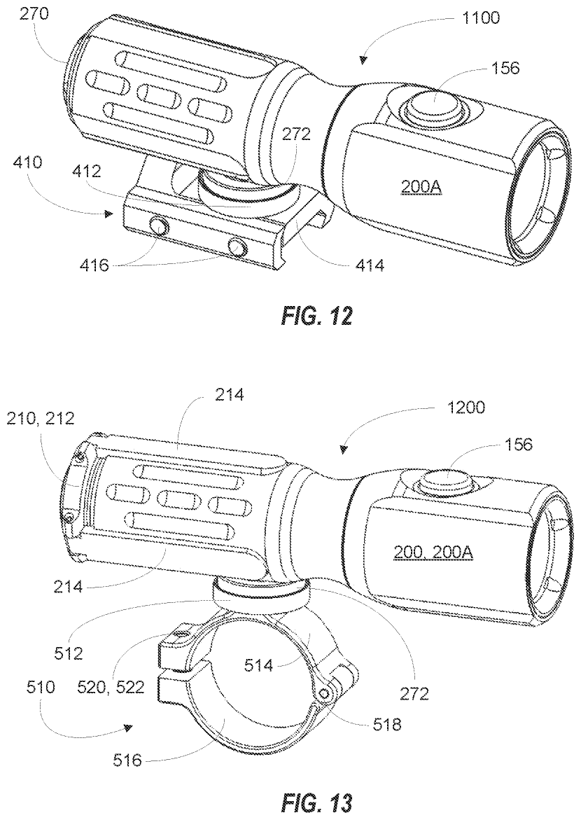

FIG. 12 is a perspective view of yet another embodiment of a light assembly 1100 including an embodiment of a picatinny rail mount accessory 410, according to the present invention. Sports shooting enthusiasts will find light assembly 1100 and its picatinny rail mount accessory 410 quite useful for adding a sport light system to a firearm with a picatinny rail. The embodiment of a light assembly 1100 illustrated in FIG. 12 may include a light assembly 200A (i.e., light assembly 200 less the tripod 210). The embodiment of a light assembly 1100 illustrated in FIG. 12 may further include a picatinny rail mount accessory 410. As with other light assembly embodiments described herein, one embodiment of a light assembly 1100 may be a kit formed of a light assembly 100 or 200 or 200A and a picatinny rail mount accessory 410 separate from each other and configured to be assembled by a user into the embodiment illustrated in FIG. 12 or other configurations based on embodiments of light assembly 100 or 200. It will be understood that other kit embodiments (not shown) may include one or more other accessories (310, 320, 350, 360 and 370) as described herein.

A picatinny rail system, also known as a MIL-STD-1913 rail, is a military standard rail interface system that provides a mounting platform for firearm accessories, such as laser sights, lighting systems, scopes and the like. Generally speaking, picatinny rail systems for use with firearms include a rail or track generally secured in parallel to the barrel axis of a firearm and a clamping feature secured to the firearm accessory. The clamping feature of such picatinny rail systems is also configured to mate with the rail or track and allow for adjustment and selective fixation along the length of the track or rail. The embodiment of a picatinny rail mount accessory 410 shown herein is the clamping feature of a picatinny rail mount system. The picatinny rail or rack to which it is configured to attach is not shown in FIG. 12 for simplicity, but such rails are well known to those of ordinary skill in the art and thus, will not be further elaborated herein. The embodiment of a picatinny rail mount accessory 410 illustrated in FIG. 12 includes a picatinny circular magnetic coupling 412 affixed to a rail clamp 414 having locking screws 416 (two shown) for securing the rail clamp 414 to a picatinny rail (not shown). The picatinny circular magnetic coupling 412 may be configured to magnetically couple to radial circular magnetic coupling 272 as shown. It will be understood that in other configurations, the picatinny circular magnetic coupling 412 may be configured to magnetically couple to a coaxial circular magnetic coupling 270 or to an external circular magnetic coupling 240 of tripod 210 (also not shown in FIG. 12). It will be further understood that to the extent picatinny rail systems are well known in the art, the picatinny rail mount accessory 410 disclosed herein is believed to be novel and nonobvious at least in part because of its picatinny circular magnetic coupling 412 and capability of magnetically coupling to the various magnetic couplings 240, 270 and particularly 272 disclosed herein and by extension the added capability to support embodiments of light assemblies 100, 200 and 200A disclosed herein.

FIG. 13 is a perspective view of yet another embodiment of a light assembly 1200 including an embodiment of a light assembly 200 and an embodiment of a barrel mount accessory 510, according to the present invention. Light assembly 200 may be configured as described elsewhere herein, namely a light assembly 200A with tripod 210 (shown in FIG. 13 mounted to the coaxial circular magnetic coupling 270 (not visible in FIG. 13). The embodiment of a barrel mount accessory 510 may include an upper half ring 514 and a lower half ring 516 rotationally coupled to one another via hinge 518. The upper 514 and lower 516 half rings may be secured together at ends opposite the hinge 518 via a screw 520. The upper half ring 514 may further be configured with a barrel circular magnetic mount 512 disposed half way between the hinge and threaded hole 522 formed to receive screw 520. The barrel circular magnetic mount 512 may be configured to magnetically couple to the radial circular magnetic coupling 272 of light assembly 1200 and 200, as shown in the illustrated embodiment of FIG. 13.

It will be understood that according other configurations, the barrel circular magnetic mount 512 may be configured to magnetically couple to the coaxial circular magnetic coupling 270 of light assembly 200 or external circular magnetic coupling 240 of tripod 210. As one might suspect, the barrel mount accessory 510 may be configured to mount around the barrel of a firearm (neither shown) thereby allowing the light assembly 1200 to direct its light beam in parallel to the barrel axis (also not shown) thereby illuminating a target (again, not shown) of the firearm. The mounting of light assembly 1200 to a firearm barrel is analogous to the mounting of a rifle scope to a firearm barrel and the procedure for doing so will be well understood by one of ordinary skill in the art and thus will not be further elaborated herein. It will be further understood that the barrel mount accessory 510 may be configured to mount around any generally cylindrical body, not just a firearm barrel, for example and not by way of limitation, a hollow pipe, or a solid rod, etc. Finally, it will be understood that the light assembly 1200 may be provided in kit form embodiment, namely separate components (200, 200A, 210 and 510) to be assembled as desired by the user.

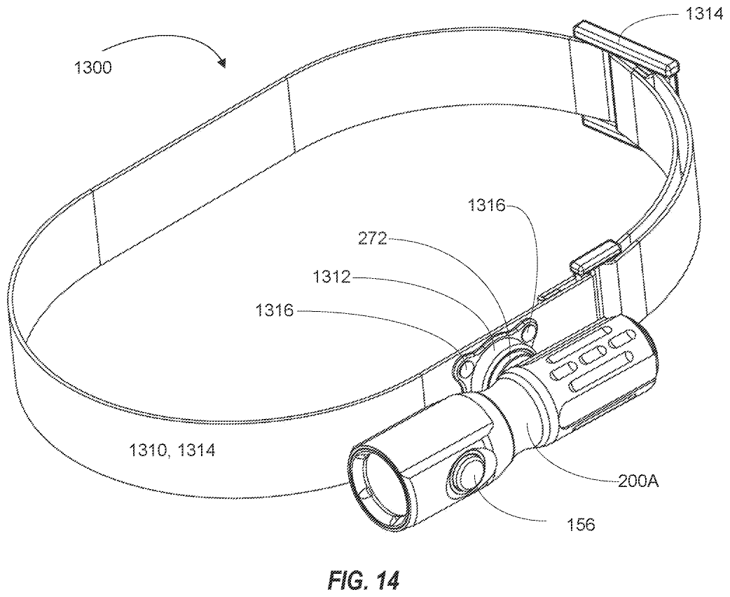

FIG. 14 is a perspective view of yet another embodiment of a light assembly 1300 including an embodiment of a belt mount accessory 1310, according to the present invention. The illustrated embodiment of light assembly 1300 may include a light assembly 200A with its associated switch 156, radial circular magnetic coupling 272 and coaxial circular magnetic coupling 270 as described elsewhere herein. The illustrated embodiment of belt mount accessory 1310 may include an adjustable length belt 1314 and buckle 1318. The embodiment of belt 1314 may further include a belt circular magnetic mount 1312 secured to the belt 1314 by a plurality of rivets 1316 (two shown, but two other rivets may be hidden from the view of FIG. 14). Embodiments of belt 1314 may be formed of any suitable material including, but not limited to, nylon webbing, leather or other synthetic materials from which belts are commonly constructed.

It will be understood that any suitable means for adjusting and securing the length of the belt 1314, for example and not by way of limitation, hook and loop closures, pin buckles with associated belt holes, clamping buckles, ratchet straps, etc., may be used consistent with the teachings of the present invention and are contemplated to be within the scope of the present invention. As with other illustrated embodiments, light assembly 1300 may also be provided in kit form with separate components, namely, light assembly 200A and belt mount accessory 1310, to be assembled as desired by the user. It will be understood that light assembly 200A may rotated relative to the belt circular magnetic mount 1312 for selectively aiming of the light beam of the light assembly 200A.

FIG. 15 is a cross-sectional view of another embodiment of a light assembly 1400 according to the present invention. This embodiment of light assembly 1400 is essentially the same embodiment as light assembly 100, but also includes a magnetic tripod assembly 210 magnetically coupled to the coaxial circular magnetic coupling 270 on the proximal end 106 of light assembly 100. The cross-sectional view of light assembly 1400 shown in FIG. 15 best illustrates end cap 108, its threaded connection to battery housing 102 with O-ring 112 and coil spring 110 located generally at the proximal end 106. FIG. 15 further illustrates the disk-shaped magnet 114 mounted coaxially within end cap 108 to form coaxial circular magnetic coupling 270. Tripod 210 with its base coupling 212 and tripod arm 214 (one of three shown) are shown magnetically coupled to the coaxial circular magnetic coupling 270. Tripod 210 further includes its own disk-shaped magnet 114, which along with base coupling 212, forms external circular magnetic coupling 240. Generally centered at the bottom of battery housing 102 and secured by screws 118 (two shown) may be the radially-mounted socket 116 with a disk-shaped magnet 114 disposed therein to form the radial circular magnetic coupling 272. Waist 122 is shown toward the distal end 168 of the battery housing 102 and located generally between the annular nut 126 and the radial circular magnetic coupling 272. The battery housing 102 may then be threadedly secured to the electronics housing 138 by a retaining ring 132 and annular nut 126 and intervening O-ring 134. Electronics housing 138 further supports internal reflective surface 158 which may include a parabolic mirror to collimate light from a light source located axially within (light source not shown) and push-button switch 156 (shown generally at top of electronics housing 138). Finally, lens 162 may be secured to the distal end 168 of internal reflective surface 158 with the bezel 166 and an intervening O-ring 164.

Having described the various illustrated embodiments of light assemblies and their accessories, additional general embodiments of same will now be described, beginning with an embodiment of a light assembly. The embodiment of a light assembly may include a cylindrical-shaped battery housing configured to house a battery. The battery housing may have an assembly axis, a proximal end and a battery housing distal end. The battery housing proximal end may be configured to receive an end cap. The end cap may be configured to hold a disk-shaped magnet. The end cap and disk-shaped battery together form a coaxial circular magnetic coupling. Embodiments of the battery housing may further include a radially-mounted socket disposed on an outside surface of the battery housing and positioned between the proximal end and the battery housing distal end. This embodiment of a socket may also be configured to receive a disk-shaped magnet and together forms a radial circular magnetic coupling having a radial circular magnetic coupling axis perpendicular to the assembly axis. According to one embodiment of the light assembly, the socket may be secured to the outside of the battery housing by two screws. The battery housing distal end may be configured with a circular shoulder having an external circular groove to receive a retaining ring. This circular shoulder located on the battery housing distal end may be configured to mate with an annular nut described below and elsewhere herein. Each of the coaxial and radial circular magnetic couplings may be configured to magnetically couple to magnetic surfaces and thereby support the light assembly from such magnetic surfaces.

The embodiment of a light assembly may further include an embodiment of a cylindrical-shaped electronics housing. The embodiment of a cylindrical-shaped electronics housing may be configured to house a light source for generating a light beam. The light source is powered by the battery. The electronics housing may have an electronics housing proximal end and a distal end. The housing proximal end may be configured to mate around the circular shoulder of the battery housing. The housing proximal end further includes external threading configured to mate with threading on the annular nut. The housing proximal end still further includes an internal groove

Embodiments of a light assembly may include a light source that is an incandescent bulb or a light emitting diode (LED). According to another embodiment of the light assembly, the battery housing may narrow in diameter in a region between the battery housing distal end and the radial circular magnetic coupling. This narrowing may form a waist around a central latitude portion of the light assembly for gripping between fingers and thumb of a user.

According to another embodiment of the light assembly, the electronics housing may further be configured to house an internal reflective surface surrounding the light source. For example and not by way of limitation, this internal reflective surface may be parabolic in cross-section with the light source located at the parabolic focal point. One particular embodiment of an internal reflective surface may be configured to collimate light emanating from the light source into the light beam directed along the assembly axis and in a direction toward the distal end of the light assembly.

According to yet another embodiment, the light assembly may further include a lens enclosing the light source within the internal reflective surface, the lens held in place by a bezel threaded to the distal end of the electronics housing. According to still another embodiment, the light assembly may further include a switch located on an outer surface between the electronics housing proximal end and the distal end. The switch may be configured to provide a user with the ability to selectively energize the light source and also to turn it off.

According to one embodiment, the light assembly may further include an annular nut having an internal groove configured for receiving the retaining ring within the shoulder of the battery housing. This embodiment of an annular nut may also be configured with internal threading that can mate with counterpart threading on the electronics housing proximal end. It will be understood that the annular nut is configured to connect the battery housing to the electronics housing via spring engagement with the retaining ring and threaded engagement between the internal threading of the annular nut and the external threading on the electronics housing proximal end.

According to another embodiment of the light assembly, the end cap may further be configured to receive a coil spring. The coil spring may be configured to complete a circuit including the battery, the switch and the light source. The coil spring may be used to secure the battery within the battery housing. The use of a coil spring to complete such a circuit and to secure a battery are well known to those of ordinary skill in the art and thus will not be further elaborated herein.

According to yet another embodiment, the light assembly may further include a tripod. Embodiments of the tripod may include a tripod base coupling. Embodiments of the tripod base coupling may include a disk-shaped magnet. Embodiments of the tripod base coupling may be configured to mate with either the coaxial or the radial circular magnetic coupling. Embodiments of the tripod may further include three tripod arms, each tripod arm rotationally coupled to the tripod base coupling at a proximal arm end and extending outward from the proximal arm end toward a distal foot end. It will be understood that each tripod arm may independently rotate relative to the tripod base coupling in order to accommodate uneven surfaces for supporting various embodiments of the light assembly.

According to still another embodiment, the light assembly may further include three equidistant arm slots extending from the proximal end toward the distal end and parallel to the assembly axis and configured for receiving the three tripod arms when magnetically coupled to the coaxial circular magnetic coupling in a folded configuration. According to yet another embodiment of the light assembly, an open position of the tripod mounted to the coaxial circular magnetic coupling may include each of the three arms rotationally extending from the base coupling with each arm distal foot end displaced radially away from the assembly axis, such that each arm distal foot end may rest on a horizontal surface to support the assembly axis oriented in a vertical direction. According to still yet another embodiment of the light assembly, when the base coupling of the tripod is coupled to the radial circular magnetic coupling, the tripod may be configured in an open position, thereby supporting the light assembly on a horizontal surface to support the assembly axis of the light assembly oriented in a horizontal direction. It will be understood that the light assembly with its tripod may also be supported on an uneven or non-horizontal and directed as the user desires.

In addition to a tripod as a removable and magnetically attachable accessory for use with the various embodiments of a light assembly disclosed herein, various other removable and magnetically attachable accessories are also disclosed and claimed herein. For example, one embodiment of the light assembly may further include a bendable extension arm. Embodiments of a bendable extension arm may include a flexible pipe. Embodiments of a bendable extension arm may further include extension arm magnetic couplings located at opposite ends of the flexible pipe. Each of the extension arm magnetic couplings may be configured to mate with either the coaxial or the radial circular magnetic coupling located on the battery housing of an embodiment of a light assembly. It will be understood that each extension arm magnetic coupling may be further configured for magnetic coupling to any magnetic metal surface. In this way, the light assembly may be supported from the magnetic metal surface. Additionally, the bendable extension arm may be configured to selectively position the light beam of the light assembly in any desired direction.

According to still another embodiment, the light assembly may further include a carabiner accessory. The embodiment of a carabiner accessory may include a circular magnetic ring including a disk-shaped magnet at a proximal ring end. The circular magnetic ring may be configured to magnetically couple with either the coaxial or the radial circular magnetic coupling. The circular magnetic ring may further include an annular opening opposite the proximal ring end. The embodiment of a carabiner accessory may further include a carabiner configured to mechanically couple through the annular opening. The carabiner accessory gives the user of an embodiment of a light assembly the option to indirectly attach the light assembly or any other accessory

According to one embodiment, the light assembly may further include a spring clip accessory. The embodiment of a spring clip accessory may include a first clip arm having a first clip arm outer surface, a first clip arm inner surface, a first distal end, a first proximal end and a first row of teeth disposed along the first clip arm inner surface and extending from the first distal end. The embodiment of a spring clip accessory may further include a clip circular magnetic coupling affixed to the first slip arm outer surface, the clip circular magnetic coupling configured to magnetically couple to either the coaxial or the radial circular magnetic coupling of the light assembly. The embodiment of a spring clip accessory may further include a second clip arm having a second clip arm outer surface, a second clip arm inner surface, a second distal end, a second proximal end and a second row of teeth disposed along the second clip arm inner surface and extending from the second distal end. The embodiment of a spring clip accessory may further include a spring pivot mechanism connected to the inner surfaces of the first and the second clip arms, the spring pivot mechanism biasing the first and the second distal ends and their associated first and second rows of teeth of the first and the second clip arms toward each other. The spring pivot mechanism will conversely bias the first and the second proximal ends of the first and the second clip arms away from each other. The embodiment of a spring clip accessory may further be configured to grip an object between the first and second rows of teeth and thereby support the light assembly from the position of the object being gripped.

According to another embodiment, the light assembly may further include a sliding spring clip accessory. The embodiment of a sliding spring clip accessory may include a sliding spring clip, shaped like a belt clip, having a straight arm, the straight arm including an open end, a closed end and a circular magnetic coupling affixed on an outer surface. The circular magnetic coupling may be configured to magnetically couple to either the coaxial or the radial circular magnetic coupling. The embodiment of a sliding spring clip accessory may further include a curved end arm extending from the closed end of the straight arm and ending with a lip. According to this particular embodiment, the curved end arm may be spring biased against the straight arm with the lip curved away from the straight arm.

According to yet another embodiment, the light assembly may further include an armband accessory. The embodiment of an armband accessory may include an adjustable length armband. The embodiment of an armband accessory may further include an armband circular magnetic coupling affixed to the armband and configured to magnetically couple to either the coaxial or the radial circular magnetic coupling.

According to still another embodiment, the light assembly may further include a picatinny rail mount accessory. The embodiment of a picatinny rail mount accessory may include a rail clamp with locking screws. The rail clamp may be configured to mate with a picatinny rail on an open side. The rail clamp may further include an opposite side. The embodiment of a picatinny rail mount accessory may further include a picatinny circular magnetic coupling affixed to the opposite side. The picatinny circular magnetic coupling may be configured to magnetically couple to either the coaxial or the radial circular magnetic coupling.

According to still yet another embodiment, the light assembly may further include a barrel mount accessory. The barrel mount accessory may include an upper half ring with a first pivot end and a first locking end having an upper threaded screw hole. The barrel mount accessory may further include a lower half ring with a second pivot end and a second locking end having a lower threaded screw hole. The barrel mount accessory may further include a hinge rotationally coupling the upper and the lower rings together at the first and the second pivot ends. The barrel mount accessory may further include a barrel circular magnetic coupling mounted to a convex side of the upper half ring between the first pivot end and the first locking end. The barrel circular magnetic coupling may be configured to magnetically couple to either the coaxial or the radial circular magnetic coupling. The barrel mount accessory may further include a screw for selectively locking the upper and the lower half rings around a cylindrical member. The screw is not visible in FIG. 13, but is inherent in the functionality of the illustrated embodiment of a barrel mount accessory. It will further be understood that other means of selectively locking the upper and the lower half rings around a cylindrical member will be readily apparent to one of ordinary skill in the art and may be used in place of the screw and screw hole.

According to one embodiment, the light assembly may further include a belt mount accessory. The embodiment of a belt mount accessory may include an adjustable length belt. The embodiment of a belt mount accessory may further include a belt circular magnetic coupling affixed to the belt. The belt circular magnetic coupling may also be configured to magnetically couple to either the coaxial or the radial circular magnetic coupling.

An embodiment of a light assembly kit is also disclosed. Embodiments of a light assembly kit may include one of the base embodiment light assemblies 100 and 200A and include one or more accessories as described herein. According to one embodiment, a light assembly kit may include a light assembly. This particular embodiment of a light assembly may include a cylindrical-shaped battery housing configured to house a battery. The battery housing may have an assembly axis, a proximal end and a battery housing distal end. The proximal end may be configured to receive an end cap. The end cap may be configured with a disk-shaped magnet. The end cap and disk-shaped magnet together form a coaxial circular magnetic coupling. The battery housing may further include a radially-mounted socket disposed on an outside surface between the proximal end and the battery housing distal end. The socket may also be configured to receive a disk-shaped magnet. The socket and its associated disk-shaped magnet together form a radial circular magnetic coupling having a radial circular magnetic coupling axis perpendicular to the assembly axis. The battery housing distal end may be configured with a circular shoulder having an external circular groove to receive a retaining ring. The coaxial and radial circular magnetic couplings each may be configured to magnetically couple to magnetic surfaces.

This particular embodiment of a light assembly may further include a cylindrical-shaped electronics housing configured to house a light source for generating a light beam. According to this embodiment, the light source may be powered by the battery. The electronics housing may have an electronics housing proximal end and a distal end. The housing proximal end may be configured to mate around the circular shoulder of the battery housing with external threading and an internal circular groove configured to receive an O-ring. The electronics housing may further include an internal reflective surface having a narrow end surrounding the light source. The internal reflective surface may be configured to collimate light emanating from the light source into the light beam directed along the assembly axis in a direction toward the distal end. The electronics housing may further include a lens closing a wide end of the internal reflective surface. The electronics housing may further include a bezel threaded to the distal end of the electronics housing and enclosing the distal end of the light assembly. The electronics housing may further include a switch located on an outer surface between the electronics housing proximal end and the distal end. The switch may be configured to provide a user with the ability to selectively energize the light source. The electronics housing may further include an annular nut having an internal groove configured for receiving the retaining ring within the shoulder of the battery housing and may also be configured with internal threading, The annular nut may be configured to connect the battery housing to the electronics housing via spring engagement with the retaining ring and threaded engagement between the internal threading of the annular nut and the external threading on the electronics housing proximal end.

This particular embodiment of a light assembly may further include at least one of the following accessories for magnetically coupling to the coaxial or the radial circular magnetic coupling: a tripod, a bendable extension arm, a carabiner accessory, a spring clip accessory, a sliding spring clip accessory, an armband accessory, a picatinny rail accessory, a barrel mount accessory and a belt mount accessory. Particular embodiments of each of the above accessories follows.

According to one embodiment of a light assembly kit, the embodiment of a tripod may include a tripod base coupling. The tripod base coupling may further include a disk-shaped magnet. The tripod base coupling may be configured to mate with either the coaxial or the radial circular magnetic coupling. The embodiment of a tripod may further include three tripod arms, each arm rotationally coupled to the tripod base coupling at a proximal arm end and extending outward from the proximal arm end toward a distal foot end.

According to another embodiment of a light assembly kit, the embodiment of a bendable extension arm may include a flexible pipe. The embodiment of a bendable extension arm may further include extension arm magnetic couplings disposed at opposite ends of the flexible pipe. Each of the extension arm magnetic couplings may be configured to mate with either the coaxial or the radial circular magnetic coupling.

According to another embodiment of a light assembly kit, the embodiment of a carabiner accessory may further include a circular magnetic ring including a disk-shaped magnet at a proximal ring end. The circular magnetic ring may be configured to magnetically couple with the coaxial or the radial circular magnetic coupling. The circular magnetic ring may further include an annular opening opposite the proximal ring end. The embodiment of a carabiner accessory may further include a carabiner configured to mechanically couple through the annular opening.

According to yet another embodiment of a light assembly kit, the embodiment of a spring clip accessory may further include a first clip arm having a first clip arm outer surface, a first clip arm inner surface, a first distal end, a first proximal end and a first row of teeth disposed along the first clip arm inner surface, the first row of teeth extending from the first distal end. The embodiment of a spring clip accessory may further include a clip circular magnetic coupling affixed to the first slip arm outer surface. The clip circular magnetic coupling may be configured to magnetically couple to either the coaxial or the radial circular magnetic coupling. The embodiment of a spring clip accessory may further include a second clip arm having a second clip arm outer surface, a second clip arm inner surface, a second distal end, a second proximal end and a second row of teeth disposed along the second clip arm inner surface the teeth extending from the second distal end. The embodiment of a spring clip accessory may further include a spring pivot mechanism connected to the inner surfaces of the first and the second clip arms. The spring pivot mechanism may be configured to bias the first and the second distal ends and their associated first and second rows of teeth of the first and the second clip arms toward each other. Conversely, the spring pivot mechanism may be configured to bias the first and the second proximal ends of the first and the second clip arms away from each other. The embodiment of a spring clip accessory may further be configured to grip an object between the first and second rows of teeth and thereby support the light assembly from the position of the object.

According to still another embodiment of a light assembly kit, the embodiment of a sliding spring clip accessory may further include a sliding spring clip, shaped like a belt clip, having a straight arm, the straight arm including an open end, a closed end and a circular magnetic coupling affixed on an outer surface. The circular magnetic coupling may be configured to magnetically couple to either the coaxial or the radial circular magnetic coupling. The embodiment of a sliding spring clip accessory may further include a curved end arm extending from the closed end of the straight arm and ending with lip. The curved end arm spring may be spring biased against the straight arm with the lip curved away from the straight arm.

According to still yet another embodiment of a light assembly kit, the embodiment of an armband accessory may further include an adjustable length armband. The embodiment of an armband accessory may further include an armband circular magnetic coupling affixed to the armband. The armband circular magnetic coupling may be configured to magnetically couple to either the coaxial or the radial circular magnetic coupling.

According to another embodiment of a light assembly kit, the embodiment of a picatinny rail accessory may further include a rail clamp with locking screws. The rail clamp may be configured an open side and an opposite side. The open side of the rail clamp may further be configured to mate with a picatinny rail. The embodiment of a picatinny rail accessory may further include a picatinny circular magnetic coupling affixed to the opposite side of the rail clamp. The picatinny circular magnetic coupling may further be configured to magnetically couple to either the coaxial or the radial circular magnetic coupling.

According to another embodiment of a light assembly kit, the embodiment of a barrel mount accessory may further include an upper half ring with a first pivot end and a first locking end having an upper threaded screw hole. The embodiment of a barrel mount accessory may further include a lower half ring with a second pivot end and a second locking end having a lower threaded screw hole. The embodiment of a barrel mount accessory may further include a hinge rotationally coupling the upper and the lower rings together at the first and the second pivot ends. The embodiment of a barrel mount accessory may further include a barrel circular magnetic coupling mounted to a convex side of the upper half ring between the first pivot end and the first locking end. The barrel circular magnetic coupling may be configured to magnetically couple to either the coaxial or the radial circular magnetic coupling. The embodiment of a barrel mount accessory may further include a screw for selectively locking the upper and the lower half rings around a cylindrical member.

According to another embodiment of a light assembly kit, the embodiment of a belt mount accessory may further include an adjustable length belt. The embodiment of a belt mount accessory may further include a belt circular magnetic coupling affixed to the belt. The belt circular magnetic coupling may be configured to magnetically couple to either the coaxial or the radial circular magnetic coupling.

It will be understood that the particular electronics, battery (alkaline, lithium ion, etc.), optical source (incandescent, light emitting diode (LED), etc.), wiring and circuitry which would form a complete light assembly have intentionally not been disclosed herein. This is because any suitable electronics, battery, optical source, wiring and circuitry known to those of ordinary skill in the art could be used with the embodiments of light assemblies, accessories and kits disclosed herein. It will further be understood that such conventional features do not form the novel and nonobvious aspects of this invention.

In understanding the scope of the present invention, the term “configured” as used herein to describe a component, section or part of a device includes necessary structure to carry out the desired function. In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. As used herein to describe the present invention, the following directional terms “forward, rearward, above, downward, vertical, horizontal, below and transverse” as well as any other similar directional terms refer to those directions of the illustrated embodiments of the present invention. Finally, terms of degree such as “substantially”, “about” and “approximately” as used herein mean a reasonable amount of deviation of the modified term such that the end result is not significantly changed.

It will further be understood that the present invention may suitably comprise, consist of, or consist essentially of the component parts, method steps and limitations disclosed herein. However, the invention illustratively disclosed herein suitably may be practiced in the absence of any element which is not specifically disclosed herein.

While the foregoing advantages of the present invention are manifested in the detailed description and illustrated embodiments of the invention, a variety of changes can be made to the configuration, design and construction of the invention to achieve those advantages. Hence, reference herein to specific details of the structure and function of the present invention is by way of example only and not by way of limitation.

What is claimed is:

1. A light assembly, comprising:
a cylindrical-shaped battery housing configured to house a battery, the battery housing having and an assembly axis, a proximal end and a battery housing distal end, the proximal end configured to receive an end cap, the end cap configured with a disk-shaped magnet and together forming a coaxial circular magnetic coupling, the battery housing further comprising a radially-mounted socket disposed on an outside surface between the proximal end and the battery housing distal end, the socket also configured to receive a disk-shaped magnet and together forming a radial circular magnetic coupling with a radial circular magnetic coupling axis perpendicular to the assembly axis, the battery housing distal end configured with a circular shoulder having an external circular groove to receive a retaining ring, the coaxial and radial circular magnetic couplings each configured to magnetically couple to magnetic surfaces; and
a cylindrical-shaped electronics housing configured to house a light source for generating a light beam, the light source powered by the battery, the electronics housing having an electronics housing proximal end and a distal end, the housing proximal end configured to mate around the circular shoulder with external threading and an internal groove configured to receive an O-ring.

2. The light assembly according to claim 1, wherein the light source comprises an incandescent bulb or a light emitting diode.

3. The light assembly according to claim 1, wherein the battery housing narrows in diameter in a region between the battery housing distal end and the radial circular magnetic coupling to form a waist around a central latitude portion of the light assembly for gripping between fingers and thumb of a user.

4. The light assembly according to claim 1, wherein the electronics housing is further configured to house an internal reflective surface surrounding the light source, the internal reflective surface configured to collimate light emanating from the light source into the light beam directed along the assembly axis in a direction toward the distal end.

5. The light assembly according to claim 4, further comprising a lens enclosing the light source within the internal reflective surface, the lens held in place by a bezel threaded to the distal end of the electronics housing.

6. The light assembly according to claim 1, wherein the electronics housing further comprises a switch located on an outer surface between the electronics housing proximal end and the distal end, the switch configured to provide a user with the ability to selectively energize the light source.

7. The light assembly according to claim 1, further comprising an annular nut having an internal groove configured for receiving the retaining ring within the shoulder of the battery housing and also configured with internal threading, the annular nut configured to connect the battery housing to the electronics housing via spring engagement with the retaining ring and threaded engagement between the internal threading of the annular nut and the external threading on the electronics housing proximal end.

8. The light assembly according to claim 1, wherein the socket is secured to the outside of the battery housing by two screws.

9. The light assembly according to claim 1, wherein the end cap is further configured to receive a coil spring configured to complete a circuit including the battery, the switch and the light source.

10. The light assembly according to claim 1, further comprising a tripod, the tripod comprising:
a tripod base coupling including a disk-shaped magnet, the tripod base coupling configured to mate with either the coaxial or the radial circular magnetic coupling; and
three tripod arms, each arm rotationally coupled to the tripod base coupling at a proximal arm end and extending outward from the proximal arm end toward a distal foot end.

11. The light assembly according to claim 10, wherein the battery housing further comprises three equidistant arm slots extending from the proximal end toward the distal end and parallel to the assembly axis and configured for receiving the three tripod arms when magnetically coupled to the coaxial circular magnetic coupling in a folded configuration.

12. The light assembly according to claim 10, wherein an open position of the tripod mounted to the coaxial circular magnetic coupling comprises each of the three arms rotationally extending from the base coupling with each arm distal foot end displaced radially away from the assembly axis, such that each arm distal foot end may rest on a horizontal surface to support the assembly axis oriented in a vertical direction.

13. The light assembly according to claim 10, wherein when the base coupling of the tripod is coupled to the radial circular magnetic coupling, the tripod may be configured in an open position, thereby supporting the light assembly on a horizontal surface to support the assembly axis oriented in a horizontal direction.

14. The light assembly according to claim 1, further comprising a bendable extension arm, comprising:
a flexible pipe;
extension arm magnetic couplings located at opposite ends of the flexible pipe, each of the extension arm magnetic couplings configured to mate with either the coaxial or the radial circular magnetic coupling.

15. The light assembly according to claim 14, wherein each extension arm magnetic coupling is further configured for magnetic coupling to any magnetic metal surface and thereby support the light assembly from the magnetic metal surface, the bendable extension arm thereby configured to selectively position the light beam of the light assembly in any desired direction.

16. The light assembly according to claim 1, further comprising a carabiner accessory, comprising:
a circular magnetic ring including a disk-shaped magnet at a proximal ring end, the circular magnetic ring configured to magnetically couple with the coaxial or the radial circular magnetic coupling, the circular magnetic ring further including an annular opening opposite the proximal ring end; and
a carabiner configured to mechanically couple through the annular opening.

17. The light assembly according to claim 1, further comprising a spring clip accessory, comprising:
a first clip arm having a first clip arm outer surface, a first clip arm inner surface, a first distal end, a first proximal end and a first row of teeth disposed along the first clip arm inner surface, the first row of teeth extending from the first distal end;
a clip circular magnetic coupling affixed to the first slip arm outer surface and configured to magnetically couple to either the coaxial or the radial circular magnetic coupling;
a second clip arm having a second clip arm outer surface, a second clip arm inner surface, a second distal end, a second proximal end and a second row of teeth disposed along the second clip arm inner surface, the second row of teeth extending from the second distal end;
a spring pivot mechanism connected to the inner surfaces of the first and the second clip arms, the spring pivot mechanism biasing the first and the second distal ends and their associated first and second rows of teeth of the first and the second clip arms toward each other, and the first and the second proximal ends of the first and the second clip arms away from each other; and
the spring clip accessory further configured to grip an object between the first and second rows of teeth and thereby support the light assembly from the position of the object.

18. The light assembly according to claim 1, further comprising a sliding spring clip accessory, comprising:
a sliding spring clip shaped like a belt clip having a straight arm, the straight arm including an open end, a closed end and a circular magnetic coupling affixed on an outer surface, the circular magnetic coupling configured to magnetically couple to either the coaxial or the radial circular magnetic coupling; and
a curved end arm extending from the closed end of the straight arm and ending with a lip, the curved end arm spring biased against the straight arm with the lip curved away from the straight arm.

19. The light assembly according to claim 1, further comprising an armband accessory, comprising:
an adjustable length armband; and
an armband circular magnetic coupling affixed to the armband and configured to magnetically couple to either the coaxial or the radial circular magnetic coupling.

20. The light assembly according to claim 1, further comprising a picatinny rail mount accessory, comprising:
a rail clamp with locking screws, the rail clamp configured to mate with a picatinny rail on an open side, the rail clamp further configured with an opposite side; and
a picatinny circular magnetic coupling affixed to the opposite side and configured to magnetically couple to either the coaxial or the radial circular magnetic coupling.

21. The light assembly according to claim 1, further comprising a barrel mount accessory, comprising:
an upper half ring with a first pivot end and a first locking end having an upper threaded screw hole;
a lower half ring with a second pivot end and a second locking end having a lower threaded screw hole;
a hinge rotationally coupling the upper and the lower rings together at the first and the second pivot ends;
a barrel circular magnetic coupling mounted to a convex side of the upper half ring between the first pivot end and the first locking end, the barrel circular magnetic coupling configured to magnetically couple to either the coaxial or the radial circular magnetic coupling; and
a screw for selectively locking the upper and the lower half rings around a cylindrical member.

22. The light assembly according to claim 1, further comprising a belt mount accessory, comprising:
an adjustable length belt; and
a belt circular magnetic coupling affixed to the belt and configured to magnetically couple to either the coaxial or the radial circular magnetic coupling.

23. A light assembly kit, the kit comprising:
a light assembly, the light assembly comprising:
a cylindrical-shaped battery housing configured to house a battery, the battery housing having an assembly axis, a proximal end and a battery housing distal end, the proximal end configured to receive an end cap, the end cap configured with a disk-shaped magnet and together forming a coaxial circular magnetic coupling, the battery housing further comprising a radially-mounted socket disposed on an outside surface between the proximal end and the battery housing distal end, the socket also configured to receive a disk-shaped magnet and together forming a radial circular magnetic coupling with a radial circular magnetic coupling axis perpendicular to the assembly axis, the battery housing distal end configured with a circular shoulder having an external circular groove to receive a retaining ring, the coaxial and radial circular magnetic couplings each configured to magnetically couple to magnetic surfaces; and
a cylindrical-shaped electronics housing configured to house a light source for generating a light beam, the light source powered by the battery, the electronics housing having an electronics housing proximal end and a distal end, the housing proximal end configured to mate around the circular shoulder with external threading and an internal circular groove configured to receive an O-ring, the electronics housing further comprising:
an internal reflective surface having a narrow end surrounding the light source, the internal reflective surface configured to collimate light emanating from the light source into the light beam directed along the assembly axis in a direction toward the distal end;
a lens closing a wide end of the internal reflective surface;
a bezel threaded to the distal end of the electronics housing and enclosing the distal end of the light assembly;
a switch located on an outer surface between the electronics housing proximal end and the distal end, the switch configured to provide a user with the ability to selectively energize the light source; and
an annular nut having an internal groove configured for receiving the retaining ring within the shoulder of the battery housing and also configured with internal threading, the annular nut configured to connect the battery housing to the electronics housing via spring engagement with the retaining ring and threaded engagement between the internal threading of the annular nut and the external threading on the electronics housing proximal end; and
including at least one of the following accessories for magnetically coupling to the coaxial or the radial circular magnetic coupling:
a tripod;
a bendable extension arm;
a carabiner accessory;
a spring clip accessory;
a sliding spring clip accessory;
an armband accessory;
a picatinny rail accessory;
a barrel mount accessory; and
a belt mount accessory.

24. The kit according to claim 23, wherein the tripod further comprises:
a tripod base coupling including a disk-shaped magnet, the tripod base coupling configured to mate with either the coaxial or the radial circular magnetic coupling; and
three tripod arms, each arm rotationally coupled to the tripod base coupling at a proximal arm end and extending outward from the proximal arm end toward a distal foot end.

25. The kit according to claim 23, wherein the bendable extension arm further comprises:
a flexible pipe; and
extension arm magnetic couplings disposed at opposite ends of the flexible pipe, each of the extension arm magnetic couplings configured to mate with either the coaxial or the radial circular magnetic coupling.

26. The kit according to claim 23, wherein the carabiner accessory further comprises:
a circular magnetic ring including a disk-shaped magnet at a proximal ring end, the circular magnetic ring configured to magnetically couple with the coaxial or the radial circular magnetic coupling, the circular magnetic ring further including an annular opening opposite the proximal ring end; and
a carabiner configured to mechanically couple through the annular opening.

27. The kit according to claim 23, wherein the spring clip accessory further comprises:
a first clip arm having a first clip arm outer surface, a first clip arm inner surface, a first distal end, a first proximal end and a first row of teeth disposed along the first clip arm inner surface, the first row of teeth extending from the first distal end;
a clip circular magnetic coupling affixed to the first slip arm outer surface and configured to magnetically couple to either the coaxial or the radial circular magnetic coupling;
a second clip arm having a second clip arm outer surface, a second clip arm inner surface, a second distal end, a second proximal end and a second row of teeth disposed along the second clip arm inner surface, the second row of teeth extending from the second distal end;
a spring pivot mechanism connected to the inner surfaces of the first and the second clip arms, the spring pivot mechanism biasing the first and the second distal ends and their associated first and second rows of teeth of the first and the second clip arms toward each other, and the first and the second proximal ends of the first and the second clip arms away from each other; and
the spring clip accessory further configured to grip an object between the first and second rows of teeth and thereby support the light assembly from the position of the object.

28. The kit according to claim 23, wherein the sliding spring clip accessory further comprises:
a sliding spring clip shaped like a belt clip having a straight arm, the straight arm including an open end, a closed end and a circular magnetic coupling affixed on an outer surface, the circular magnetic coupling configured to magnetically couple to either the coaxial or the radial circular magnetic coupling; and
a curved end arm extending from the closed end of the straight arm and ending with lip, the curved end arm spring biased against the straight arm with the lip curved away from the straight arm.

29. The kit according to claim 23, wherein the armband accessory further comprises:
an adjustable length armband; and
an armband circular magnetic coupling affixed to the armband and configured to magnetically couple to either the coaxial or the radial circular magnetic coupling.

30. The kit according to claim 23, wherein the picatinny rail accessory further comprises:
a rail clamp with locking screws, the rail clamp configured to mate with a picatinny rail on an open side and an opposite side; and
a picatinny circular magnetic coupling affixed to the opposite side and configured to magnetically couple to either the coaxial or the radial circular magnetic coupling.

31. The kit according to claim 23, wherein the barrel mount accessory further comprises:
an upper half ring with a first pivot end and a first locking end having an upper threaded screw hole;
a lower half ring with a second pivot end and a second locking end having a lower threaded screw hole;
a hinge rotationally coupling the upper and the lower rings together at the first and the second pivot ends;
a barrel circular magnetic coupling mounted to a convex side of the upper half ring between the first pivot end and the first locking end, the barrel circular magnetic coupling configured to magnetically couple to either the coaxial or the radial circular magnetic coupling; and
a screw for selectively locking the upper and the lower half rings around a cylindrical member.

32. The kit according to claim 23, wherein the belt mount accessory further comprises:
an adjustable length belt; and
a belt circular magnetic coupling affixed to the belt and configured to magnetically couple to either the coaxial or the radial circular magnetic coupling.
